(19) United States
(12) Patent Application Publication
(10) Pub. No.: US 2007/0232426 A1
(43) Pub. Date: Oct. 4, 2007

(54) Belt Drive for an Internal Combustion Engine

(75) Inventors: Rainer Pflug, Heilsbronn (DE); Rainer Baumueller, Herzogenaurach (DE); Thomas Bertelshofer, Ebermannstadt (DE); Peter Kelm, Herzogenaurach (DE); Tino Haensel, Emskirchen (DE); Martin Assel, Burgbernheim (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/569,633

(22) PCT Filed: Apr. 22, 2005
(86) PCT No.: PCT/EP05/04346

§ 371 Date: Dec. 5, 2006

(30) Foreign Application Priority Data
May 27, 2004 (DE) 10 2004 025 936.4

(51) Int. Cl. F16H 7/12; F16H 29/12

(52) U.S. Cl. 474/136; 74/70

(57) ABSTRACT

The invention relates to a wraparound drive for an internal combustion engine, having a wraparound means (2) which is configured as a belt or a chain and is guided over drive and output wheels (3, 5, 6) of the crankshaft (4) and at least one camshaft (7, 8) of the internal combustion engine and/or auxiliary assemblies which are to be driven.

In order to ensure reliable balancing of the drive by elimination of oscillations and resonances, there is provision for at least one of the drive or output wheels (3, 5, 6) or a deflection wheel (9) to be of unround or eccentric configuration, and/or for at least two tensioning rollers (11, 13) to be provided, one of these tensioning rollers (13) being provided with a damping device (14), or both tensioning rollers (11, 13) being coupled to one another by a damping device (14).

### FIELD OF THE INVENTION

The invention relates to a wraparound drive for an internal combustion engine, having a wraparound means which is configured as a belt or a chain and is guided over drive and output wheels of the crankshaft and at least one camshaft of the internal combustion engine and/or auxiliary assemblies which are to be driven.

### BACKGROUND OF THE INVENTION

In particular in motor vehicles having internal combustion engines, belt or chain drives are used, in which a crankshaft drives the camshafts of an internal combustion engine, which camshafts open and close the inlet and outlet valves of the engine. Moreover, auxiliary assemblies, such as a water pump, a power steering pump, an air conditioning compressor and an electrical generator, can also be driven with this or a special belt or chain drive.

Belt or chain drives of this type are subjected to mechanical oscillation excitations on account of torque fluctuations or angular velocity and rotational speed changes during operation, which mechanical oscillation excitations load the belt or chain drive for their part. These oscillations or excitations disadvantageously lead in resonance ranges to audible noise. Increased friction forces which have a negative effect on the service life of the wraparound drive and its efficiency are associated with this. Moreover, the susceptibility to faults increases and the driving comfort decreases, for example, in a motor vehicle.

DE 195 20 508 A1 has disclosed a wraparound drive for an internal combustion engine, which wraparound drive has a driving wheel, at least one driven wheel and a wraparound means. Here, at least one output wheel which is assigned to one of the camshafts is of unround configuration. For this purpose, the wheel is provided with depressions which are distributed over the circumference, the number of depressions corresponding to the dominant order of the rotational movement. It is disadvantageous here that substantially only the audible oscillation noise is eliminated.

### OBJECT OF THE INVENTION

The invention is based on the object of providing a wraparound drive for an internal combustion engine, which wraparound drive reliably ensures balancing of the wraparound drive behavior by elimination of oscillations and resonances.

### SUMMARY OF THE INVENTION

The invention is based on the finding that phase-displaced oscillation superimposition of oscillations can lead to elimination of the latter.

Accordingly, the object which is set is achieved by the fact that at least one of the drive or output wheels or a deflection wheel is of unround or eccentric configuration, and/or by the fact that at least two tensioning rollers are provided, one of these tensioning rollers being provided with a damping device, or both tensioning rollers being coupled to one another by a damping device.

As a result of the drive, output or deflection wheel which is manufactured in an unround or eccentric manner, counteroscillations to the mechanical oscillations which occur are generated. Said counteroscillations are superimposed on the oscillations which emanate from the crankshaft or camshaft or the other driven auxiliary assemblies, such as a water pump, power steering pump, fuel pump, air conditioning compressor, etc., in such a way that the oscillations of the wraparound drive are eliminated.

Furthermore, elimination of the oscillations which occur is achieved if tensioning rollers are provided which are provided with a damping device, it being possible for the tensioning rollers to be coupled to one another by the damping device. A combination with unround drive, output and/or deflection rollers can be preferred.

It is of advantage that the wraparound drive and the dynamic forces which occur on it are balanced as a result and the wraparound means is loaded to a lesser extent. The service life of the wraparound drive is therefore increased, while the susceptibility to faults drops. In particular at medium rotational speeds, a significant reduction in the nonuniformity of the running of the wraparound drive is achieved, which nonuniformity is caused by the undamped oscillations. Here, disruptive vibration and resonance noise is eliminated and the driving comfort is increased, for instance, in a motor vehicle.

There can therefore be provision, for example, for the drive, output or deflection wheel to have a geometrical shape which is triangular, polygonal or another shape which deviates from the circular shape. For example, a trapezoid shape of the wheel is possible. The selection of the shape of the wheel is dependent, in particular, on the rotational speeds which are to be expected, the oscillations and resonances which occur, and on the torque fluctuations and angular velocity changes in the wraparound drive. It goes without saying that the deviation of the belt pulley or chain sprocket geometry from the circular shape is only comparatively small, with the result that the reliable guidance of the wraparound means is ensured on the abovementioned wheels of the drive. However, this deviation is sufficiently pronounced that the technical problem on which the invention is based is solved.

According to one development of the invention, the damping device is of spring-loaded configuration, with the result that it acts on the drive, output or deflection wheel in a manner which damps oscillations.

Furthermore, one of the tensioning rollers can be arranged in the load run and the other tensioning roller can be arranged in the empty run of the wraparound drive, in order to achieve uniform oscillation damping.

As a function, in particular, of the structural conditions and the available space for the wraparound drive, the damping device can be arranged inside or outside the wraparound region of the wraparound means.

If a drive, output or deflection wheel is loaded with a spring, the resonant frequency of the damping device can be adapted in such a way that it has the same resonance as the wraparound means. Refined adaptation of the damping achieves phase displacement of the oscillations, which phase displacement eliminates the oscillations and resonances of the wraparound drive.

The oscillations and resonances can also be eliminated by the resonant frequency of the driven shaft being adapted in such a way that it has the same resonance as the wraparound means.

### BRIEF DESCRIPTION OF THE DRAWINGS

The invention will be explained in the following text in greater detail using several embodiments and by way of the appended drawings, in which:

FIG. 1 shows a diagram of the rotational speed fluctuation, for example, of a camshaft and the rotational speed oscillation of a drive wheel in a wraparound drive according to the invention,

FIG. 2 shows a diagrammatic illustration of a wraparound drive having an unround drive wheel,

FIGS. 3 to 5 show different shapes of a drive wheel for eliminating oscillations in the wraparound drive,

FIG. 6 shows a diagrammatic illustration of a wraparound drive having a damping device,

FIG. 7 shows a diagrammatic illustration of a wraparound drive having a damping device according to FIG. 6, in a further embodiment, and

FIG. 8 shows a diagrammatic illustration of a wraparound drive having a damping device, in a third embodiment.

### DETAILED DESCRIPTION OF THE DRAWINGS

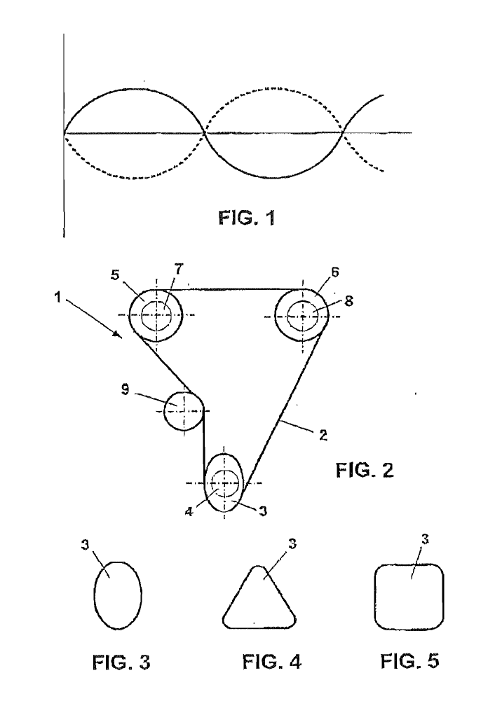

The diagram which is illustrated in FIG. 1 shows, by way of the continuous line, the profile of the rotational speed oscillation, for example, of a camshaft and, by way of the dashed line, the profile of the rotational speed oscillation of an unround drive wheel during operation of an internal combustion engine. These oscillations are superimposed in such a way that they eliminate each other and the wraparound drive is therefore balanced during operation.

The wraparound drive 1 according to FIG. 2 and FIG. 6 to FIG. 8 of an internal combustion engine (not shown) comprises a wraparound means 2 which is configured as an endless belt. The latter wraps around a drive wheel 3 of the crankshaft 4 and two output wheels 5 and 6 of two camshafts 7 and 8 of the internal combustion engine which are spaced apart from one another.

In the embodiment according to FIG. 2, a deflection wheel 9 which is partially wrapped around by the wraparound means 2 is arranged between the crankshaft 4 and the camshaft 7. Furthermore, the drive wheel 3 of the crankshaft 4 is of unround configuration and has an elliptic shape here. Its unround running during operation of the wraparound drive brings about superimposition of the oscillations which occur according to the functioning principle which is shown in FIG. 1 and eliminates them.

FIG. 3 shows the elliptic shape of the drive wheel 3 of the crankshaft 4, while FIG. 4 represents a substantially triangular shape of the drive wheel 3. Finally, the drive wheel 3 in FIG. 5 is of substantially rectangular configuration. The deviations of the circumferential geometry of a drive wheel of this type from the circular geometry are only so great here, however, that the intended elimination of the abovementioned oscillations takes place.

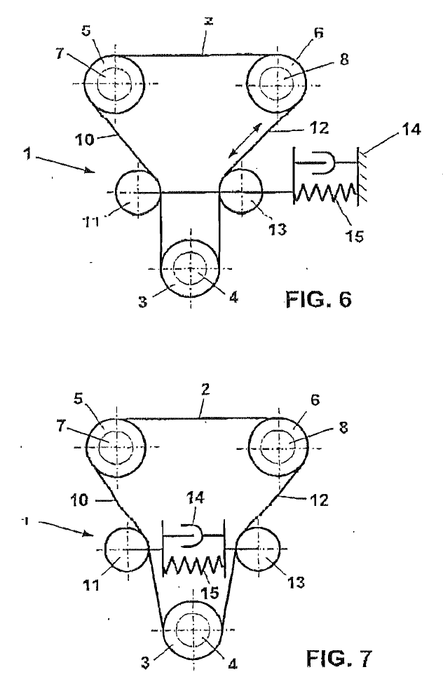

According to FIG. 6, a first tensioning roller 11 is arranged in the load run 10 of the wraparound drive 1, that is to say between the crankshaft 4 and the first camshaft 7, and a further tensioning roller 13 is arranged in the empty run 12, that is to say between the second camshaft 8 and the crankshaft 4. Both tensioning rollers 11 and 13 are coupled to one another by a spring-loaded damping device 14. The spring 15 of the damping device 14 therefore ensures uniform tensioning of both tensioning rollers 11 and 13 during operation of the wraparound drive 1, in order to eliminate oscillations and resonances which occur. Here, the damping device 14 is arranged outside the wraparound region of the wraparound means 2.

In the embodiment which is shown in FIG. 7, the damping device 14 is positioned within the wraparound region of the wraparound means 2, if the spare conditions in the wraparound drive 1 permit.

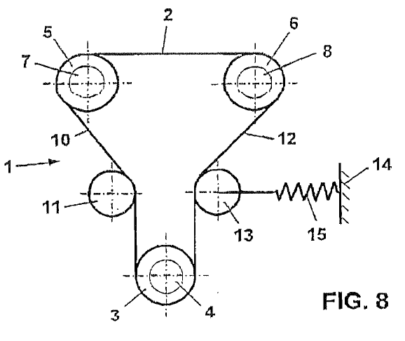

FIG. 8 shows one embodiment of the wraparound drive 1 having two tensioning rollers 11 and 13, only the tensioning roller 13 being spring-loaded by a spring 15, while the rotational axis of the tensioning roller 11 is fixed in relation to the rotational axes of the drive wheels 4, 5, 6. A refinement of this type of the wraparound drive can also be suitable on its own or in combination with an unround drive or output wheel 3, 4, 5 or deflection wheel 13, 14, in order to superimpose, to minimize or to eliminate oscillations of the wraparound drive.

### List of Designations

1 Wraparound drive
2 Wraparound means
3 Drive wheel
4 Crankshaft
5 Output wheel
6 Output wheel
7 Camshaft
8 Camshaft
9 Deflection wheel
10 Load run
11 Tensioning roller
12 Empty run
13 Tensioning roller
14 Damping device
15 Spring

1. A wraparound drive for an internal combustion engine, comprising a wraparound means which is configured as a belt or a chain and is guided over drive and output wheels of the crankshaft and at least one camshaft of the internal combustion engine and/or auxiliary assemblies which are to be driven, wherein at least one of the drive or output wheels or a deflection wheel is of unround or eccentric configuration, and/or in that at least two tensioning rollers are provided, one of these tensioning rollers being provided with a damping device, or both tensioning rollers being coupled to one another by a damping device.

2. The wraparound drive as claimed in claim 1, wherein the drive, output or deflection wheel has a circumferential geometry which is elliptic, polygonal or another shape which deviates from circular.

3. The wraparound drive as claimed in claim 1, wherein the damping device is of spring-loaded configuration.

4. The wraparound drive as claimed in claim 1, wherein one of the tensioning rollers is arranged in the load run and the other tensioning roller is arranged in the empty run of the wraparound drive.

5. The wraparound drive as claimed in claim 1, wherein the damping device is arranged inside or outside the wraparound region of the wraparound means.

6. The wraparound drive as claimed in claim 1, wherein the resonant frequency of the damping device is adapted in such a way that it has the same resonance as the wraparound means.

7. The wraparound drive as claimed in claim 1, wherein the resonant frequency of the driven shaft is adapted in such a way that it has the same resonance as the wraparound means.
